(19) United States
(12) Patent Application Publication
(10) Pub. No.: US 2008/0007678 A1
(43) Pub. Date: Jan. 10, 2008

(54) LIQUID CRYSTAL DISPLAY DEVICE

(76) Inventor: Takaharu OGINO, Ishikawa-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/774,286

(22) Filed: Jul. 6, 2007

(30) Foreign Application Priority Data
Jul. 7, 2006 (JP) 2006-188474

(51) Int. Cl. G02F 1/1335

(52) U.S. Cl. 349/113

(57) ABSTRACT

A liquid crystal display device includes a plurality of pixels which are arrayed in a matrix. Each of the pixels has a reflection pattern which is configured such that a plurality of projections protruding from a substrate major surface are regularly arranged. Each of the projections has such a shape as to have a major axis in the substrate major surface. A first reflection pattern in a first pixel differs from a second reflection pattern in a second pixel which neighbors the first pixel.

### CROSS-REFERENCE TO RELATED APPLICATIONS

This application is based upon and claims the benefit of priority from prior Japanese Patent Application No. 2006-188474, filed Jul. 7, 2006, the entire contents of which are incorporated herein by reference.

### BACKGROUND OF THE INVENTION

1. Field of the Invention

The present invention relates generally to a liquid crystal device, and more particularly to a liquid crystal display device having a reflection pattern on a major surface of a substrate and having a function of displaying an image by selectively reflecting ambient light.

2. Description of the Related Art

A display device, such as a liquid crystal display device, includes a display area which is composed of matrix-arrayed pixels. The display area includes a plurality of scanning lines which extend in a row direction of the display pixels, a plurality of signal lines which extend in a column direction of the display pixels, switching elements which are disposed near intersections of the scanning lines and signal lines, and a pixel electrode which is connected to each of the switching elements.

In a liquid crystal display device which is capable of effecting reflective display, a reflection pattern comprising a plurality of projection portions protruding from a major surface of a substrate is provided in each pixel (see, e.g. Jpn. Pat. Appln. KOKAI Publication No. 2004-212945 and Jpn. Pat. Appln. KOKAI Publication No. 10-319422).

In this reflective liquid crystal display device, there has been a demand for an improvement of reflectance in a specified direction, or reflectance in a frontal direction (i.e. a normal direction of a liquid crystal display panel) with respect to incident light from a specified direction. Further, in the reflective liquid crystal display device, there has been a demand for suppression of occurrence of moire due to interference of reflective light.

### BRIEF SUMMARY OF THE INVENTION

The present invention has been made in consideration of the above-described problems, and the object of the invention is to provide a liquid crystal display device having a reflective display function which can display an image with a high display quality.

According to an aspect of the present invention, there is provided a liquid crystal display device including a plurality of pixels which are arrayed in a matrix, comprising: a first substrate having, in each of the pixels, a reflection pattern which is configured such that a plurality of projections protruding from a substrate major surface are regularly arranged; a second substrate which is disposed to be opposed to the first substrate; and a liquid crystal layer which is held between the first substrate and the second substrate, wherein each of the projections has such a shape as to have a major axis in the substrate major surface, a first reflection pattern in a first pixel differs from a second reflection pattern in a second pixel which neighbors the first pixel in a row direction of the first pixel, and each of the first reflection pattern and the second reflection pattern is asymmetric with respect to a center line of the pixel, which extends in a direction that is perpendicular to the major axis of each projection.

The present invention may provide a liquid crystal display device having a reflective display function which can display an image with a high display quality.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display device having a reflective display function according to an embodiment of the present invention;

FIG. 2 schematically shows a cross-sectional structure of one pixel in the liquid crystal display device shown in FIG. 1;

FIG. 3 schematically shows an example of a reflection pattern which is applicable to the liquid crystal display device shown in FIG. 2;

FIG. 4 schematically shows another example of the reflection pattern which is applicable to the liquid crystal display device shown in FIG. 2;

FIG. 5 schematically shows a first example of the structure of the reflection pattern which is applicable to the liquid crystal display device shown in FIG. 2;

FIG. 6 schematically shows a second example of the structure of the reflection pattern which is applicable to the liquid crystal display device shown in FIG. 2;

FIG. 7 schematically shows a third example of the structure of the reflection pattern which is applicable to the liquid crystal display device shown in FIG. 2;

FIG. 8 schematically shows a fourth example of the structure of the reflection pattern which is applicable to the liquid crystal display device shown in FIG. 2;

FIG. 9 schematically shows a fifth example of the structure of the reflection pattern which is applicable to the liquid crystal display device shown in FIG. 2;

FIG. 10 schematically shows a sixth example of the structure of the reflection pattern which is applicable to the liquid crystal display device shown in FIG. 2; and

FIG. 11 is a view for explaining the directivity of reflective light by the reflection pattern.

### DETAILED DESCRIPTION OF THE INVENTION

A liquid crystal display device according to an embodiment of the present invention will now be described with reference to the accompanying drawings. In this embodiment, a reflective liquid crystal display device, in which each pixel is composed of only a reflective part that displays an image by selectively reflecting ambient light, is described by way of example. However, based on the embodiment to be described below, the same advantageous effects can be obtained if the invention is applied to a liquid crystal display device having a reflective part at least at a part of the display region, for example, a transflective liquid crystal display device in which a transmissive part that displays an image by selectively passing backlight is provided in addition to the reflective part in each pixel, or a partial reflective liquid crystal display device in which a reflective part is provided at a part of the display region.

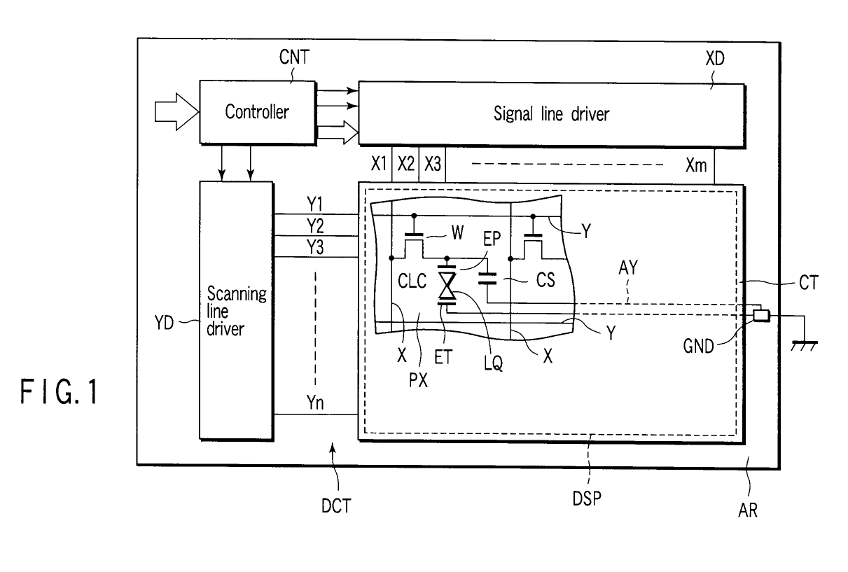

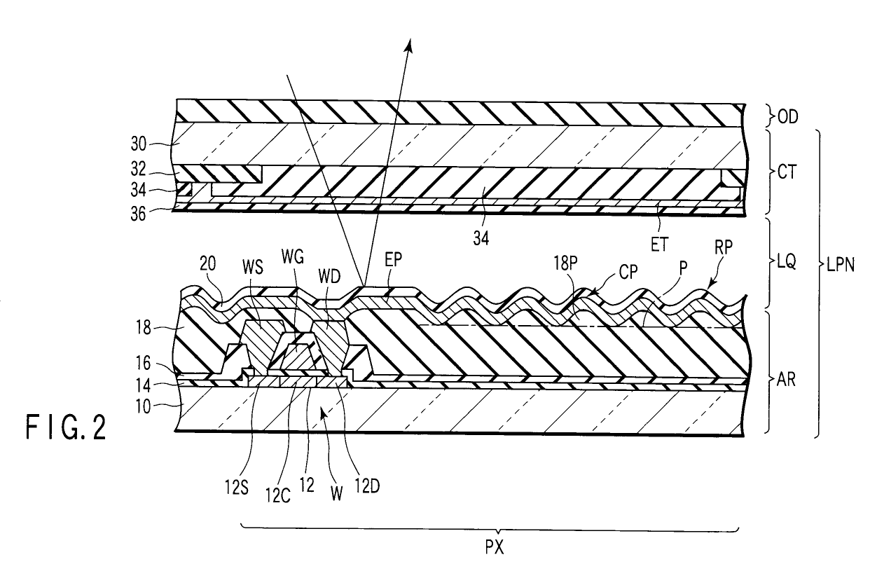

As is shown in FIG. 1 and FIG. 2, the liquid crystal display device is an active-matrix-type reflective color liquid crystal device, which includes a liquid crystal display panel LPN. The liquid crystal display panel LPN is configured to include an array substrate (first substrate) AR, a counter-substrate (second substrate) CT which is disposed to be opposed to the array substrate AR, and a liquid crystal layer LQ which is held between the array substrate AR and the counter-substrate CT. The liquid crystal display device includes an optical element OD which is provided on one of outer surfaces of the liquid crystal display panel LPN (i.e. an outer surface of the counter-substrate CT, which is opposed to the other outer surface thereof holding the liquid crystal layer LQ).

The liquid crystal display device includes a plurality of pixels PX which are arrayed in a matrix of m×n in a display region DSP that displays an image.

The array substrate AR is formed by using an insulating substrate 10 having light transmissivity, such as a glass plate or a quartz plate. Specifically, the array substrate AR includes, in the display region DSP, an (m×n) number of pixel electrodes EP which are disposed in the respective pixels, an n-number of scanning lines Y (Y1 to Yn) which are formed in the row direction of the pixel electrodes EP, an m-number of signal lines X (X1 to Xm) which are formed in the column direction of the pixel electrodes EP, an (m×n) number of switching elements W (e.g. thin-film transistors) which are disposed near intersections of the scanning lines Y and signal lines X in the respective pixels PX, and storage capacitance lines AY which are capacitive-coupled to the pixel electrodes EP so as to constitute storage capacitances CS in parallel with liquid crystal capacitances CLC.

Further, in a driving circuit region DCT at the periphery of the display region DSP, the array substrate AR includes at least a part of a scanning line driver YD which is connected to the n-number of scanning lines Y and at least a part of a signal line driver XD which is connected to the m-number of signal lines X. The scanning line driver YD successively supplies scanning signals (driving signals) to the n-number of scanning lines Y on the basis of the control by a controller CNT. The signal line driver XD supplies, under the control of the controller CNT, video signals (driving signals) to the m-number of signal lines X at a timing when the switching elements W of each row are turned on by the scanning signal. Thereby, the pixel electrodes EP in each row are set at pixel potentials corresponding to the video signals that are supplied via the associated switching elements W.

Each of the switching elements W is composed of, for instance, a thin-film transistor, and includes a semiconductor layer 12 which is disposed on the insulating substrate 10. The semiconductor layer 12 can be formed by using, e.g. polysilicon or amorphous silicon. In this embodiment, the semiconductor layer 12 is formed of polysilicon. The semiconductor layer 12 includes a source region 12S and a drain region 12D, between which a channel region 12C is interposed. The semiconductor layer 12 is covered with a gate insulation film 14.

A gate electrode WG of the switching element W is connected to one associated scanning line Y (or formed integral with the scanning line Y). The gate electrode WG, together with the scanning line Y and storage capacitance line AY, is disposed on the gate insulation film 14. The gate electrode WG, scanning line Y and storage capacitance line AY are covered with an interlayer insulation film 16.

A source electrode WS and a drain electrode WD of the switching element W are disposed on the interlayer insulation film 16 on both sides of the gate electrode WG. The source electrode WS is connected to one associated signal line X (or formed integral with the signal line X) and is put in contact with the source region 12S of the semiconductor layer 12. The drain electrode WD is connected to one associated pixel electrode EP (or formed integral with the pixel electrode EP) and is put in contact with the drain region 12D of the semiconductor layer 12. The source electrode WS, drain electrode WD and signal line X are covered with an organic insulation film 18.

The pixel electrode EP is disposed on the organic insulation film 18 and is electrically connected to the drain electrode WD via a contact hole formed in the organic insulation film 18. The pixel electrode EP is formed of a light-reflective metal film of, e.g. aluminum. The organic insulation film 18 has a plurality of protrusions 18P on its surface, which protrudes from a major surface P of the array substrate AR. The pixel electrode EP is disposed so as to cover the protrusions 18P of the organic insulation film 18, and forms a reflection pattern RP. The reflection pattern RP is composed of regularly arranged projections CP in each pixel. The pixel electrodes EP corresponding to all the pixels PX are covered with an alignment film 20.

On the other hand, the counter-substrate CT is formed by using a light-transmissive insulating substrate 30 of, e.g. glass or quartz. Specifically, the counter-substrate CT includes, in the display region DSP, a black matrix 32 which partitions the pixels PX, a color filter 34 which is surrounded by the black matrix 32 and is disposed in association with each pixel, and a counter-electrode ET.

The black matrix 32 is disposed to be opposed to wiring lines, such as scanning lines Y and signal lines X, which are provided on the array substrate AR. The color filter 34 is formed of colored resins of a plurality of colors, for example, the three primary colors of red, blue and green. The red colored resin, blue colored resin and green colored resin are disposed in association with a red pixel, a blue pixel and a green pixel, respectively.

The counter-electrode ET is disposed to be opposed to the pixel electrodes EP of the plural pixels PX. The counter-electrode ET is formed of a light-transmissive metal film of, e.g. indium tin oxide (ITO). The counter-electrode ET is covered with an alignment film 36.

When the counter-substrate CT and array substrate AR are disposed such that their alignment films 20 and 36 are opposed, a predetermined gap is provided by spacers (not shown) which are disposed between the alignment films 20 and 36. The liquid crystal layer LQ is composed of a liquid crystal composition including liquid crystal molecules, which is sealed in the gap between the alignment film 20 of the array substrate AR and the alignment film 36 of the counter-substrate CT.

The optical element OD controls a polarization state of light that passes therethrough, and is configured to include at least a polarizer plate. The polarization state of ambient light, which is incident on the optical element OD, is converted to a predetermined polarization state while the ambient light is passing through the optical element OD. The ambient light, which emerges from the optical element OD, enters the liquid crystal layer LQ while keeping the predetermined polarization state. The incident light in the liquid crystal layer LQ is reflected by the pixel electrode EP. The reflective light is made incident on the optical element OD once again, and is selectively passed therethrough. Thereby, an image is displayed.

As regards the above-described reflective liquid crystal display device, in order to meet a demand for improvement in reflectance, use is made of the reflection pattern RP which is composed of projections CP that are arranged on the basis of predetermined regularity. However, in the case where the same reflection pattern is applied to each pixel, moire due to interference of reflective light tends to easily occur because of the regularity of the arrangement of projections CP. This may lead to degradation in display quality.

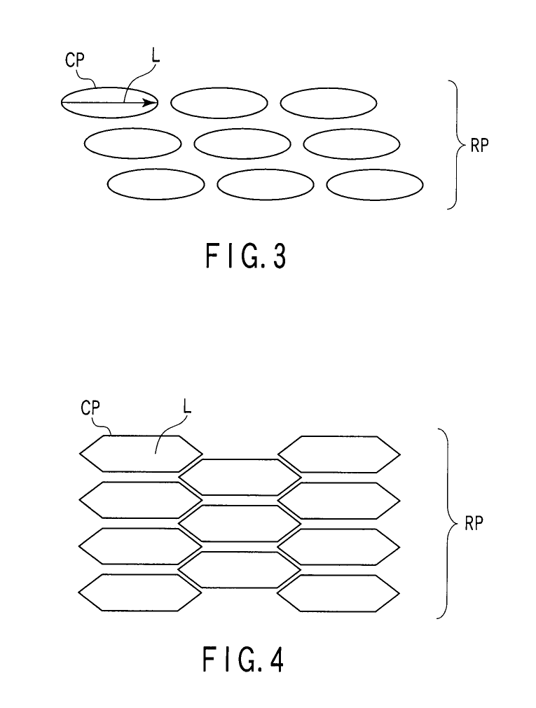

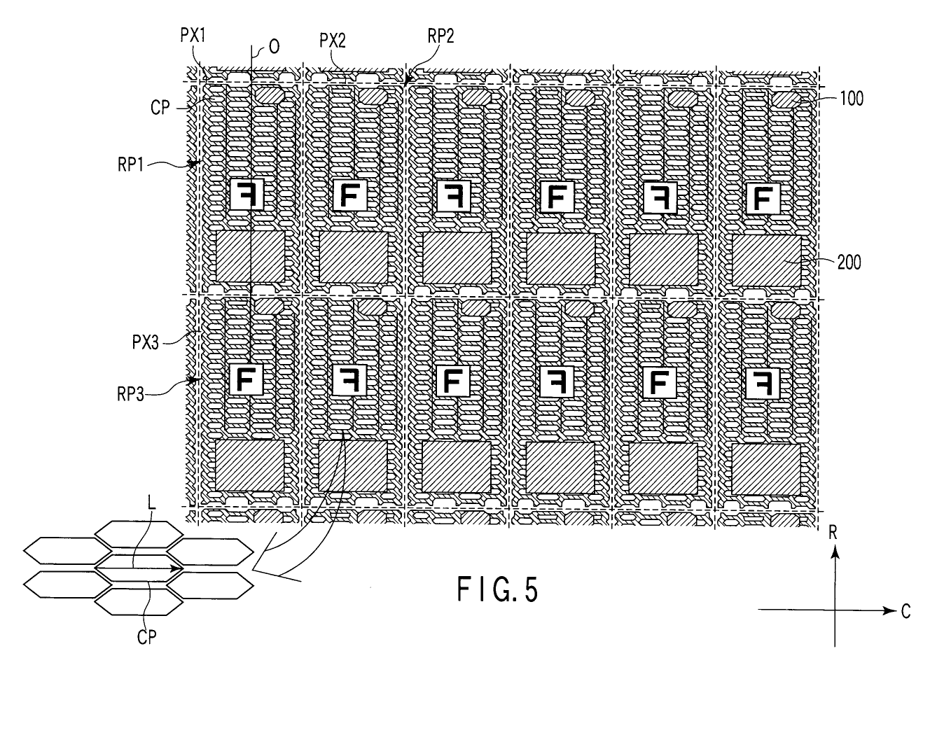

To cope with this problem, in the present embodiment, different reflection patterns are applied to neighboring pixels. Specifically, as shown in FIG. 3 and FIG. 4, the reflection pattern RP is formed of a plurality of projections CP each having such a shape as to have a major axis L in the major surface of the substrate. In the example shown in FIG. 3, each of the projections CP has an elliptic shape with a major axis L. The projections CP are arranged such that their major axes L are substantially parallel. In the example shown in FIG. 4, each of the projections CP has a hexagonal shape with a major axis L. These projections CP are arranged such that their major axes L are substantially parallel. The shape of each projection CP is not limited to the hexagon, and may be other polygons. It is preferable that the projections CP be arranged with a maximum density.

Next, a description is given of examples of the structure of the reflection pattern RP in the case where hexagonal projections CP are applied. Symbols described in the respective pixels in FIG. 5 to FIG. 10 indicate directions of the reflection patterns at the time when the reflection pattern in the upper left pixel (first pixel) in each Figure is set as a reference reflection pattern. In each example of the structure, each pixel PX has a substantially rectangular shape having a short side in a row direction C and a long side in a column direction R. The reflection pattern RP of each pixel PX is formed of a plurality of projections CP which are arranged such that their major axes are parallel to the row direction C. In the examples, the reflection pattern RP is formed with a highest-density arrangement in which one projection is surrounded by six projections.

### FIRST EXAMPLE OF STRUCTURE

As is shown in FIG. 5, a reflection pattern RP of each of pixels PX is asymmetric with respect to a center line O of the pixel, which extends in the column direction R that is perpendicular to the major axis L of each projection CP. Specifically, the projections CP are provided in four columns in each pixel PX. The projections of the two columns, which are disposed near the center line O, have longer major axes L than the projections of the other columns which are away from the center line O. In addition, the projections of the two columns, which are disposed near the center line O, are arranged in a staggered fashion in the column direction R. In this structure, the layouts of left-hand projections and right-hand projections are asymmetric with respect to the center line O.

In the first to sixth examples of the structure, 100 denotes a contact hole, and 200 denotes an transmissive aperture.

If the first pixel PX1 is set as a reference pixel, each of a first reflection pattern RP1 of the first pixel PX1 and a second reflection pattern RP2 of a second pixel PX2, which neighbors the first pixel PX1 in the row direction C, is asymmetric with respect to the center line of each pixel. In addition, the second reflection pattern RP2 corresponds to a pattern which is obtained by inverting the first reflection pattern RP1 about the center line O in the right-and-left direction. In short, the first reflection pattern RP1 and second reflection pattern RP2 are disposed in a mirror-image relationship with respect to the boundary therebetween.

A third reflection pattern RP3 of a third pixel PX3, which neighbors the first pixel PX1 in the column direction R, is identical to the second reflection pattern RP2. In short, the first pixel PX1 has the reflection pattern that is different from each of the reflection pattern of the second pixel PX2 neighboring the first pixel PX1 in the row direction C and the reflection pattern of the third pixel PX3 neighboring the first pixel PX1 in the column direction R.

With this structure, interference of reflective light between neighboring pixels can be suppressed, and the occurrence of moire can be reduced. Therefore, an image with good display quality can be displayed by making use of the reflective display function.

### SECOND EXAMPLE OF STRUCTURE

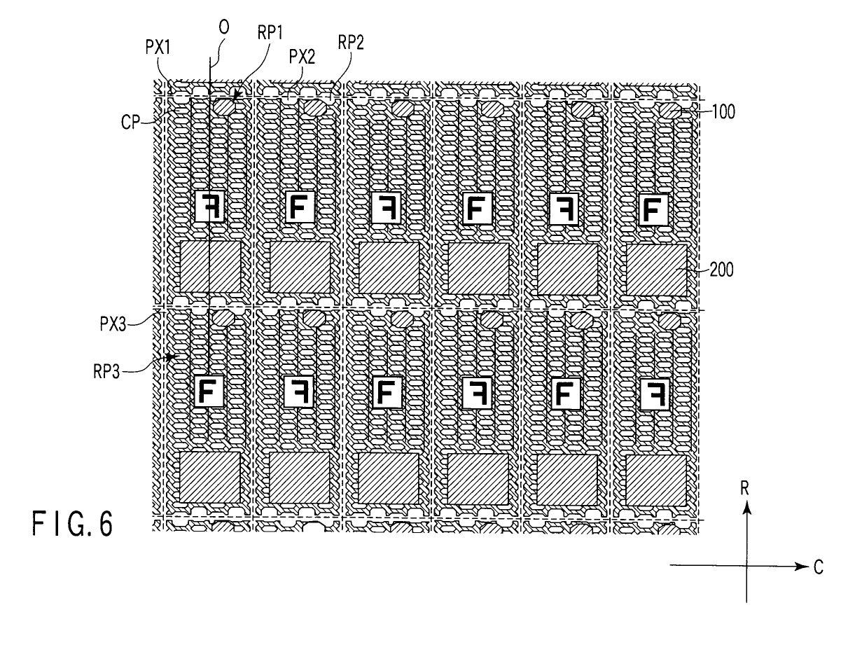

As is shown in FIG. 6, a reflection pattern RP of each of pixels PX is asymmetric with respect to a center line O of the pixel, which extends in the column direction R that is perpendicular to the major axis L of each projection CP. Specifically, the projections CP are provided in four columns in each pixel PX, and the projections CP of all the columns have the major axes L of the same length. The projections of the two columns, which are disposed near the center line O, are arranged in a staggered fashion in the column direction R. In this structure, too, the layouts of left-hand projections and right-hand projections are asymmetric with respect to the center line O.

If the first pixel PX1 is set as a reference pixel, each of a first reflection pattern RP1 of the first pixel PX1 and a second reflection pattern RP2 of a second pixel PX2, which neighbors the first pixel PX1 in the row direction C, is asymmetric with respect to the center line O of each pixel. In addition, the second reflection pattern RP2 corresponds to a pattern which is obtained by inverting the first reflection pattern RP1 about the center line O in the right-and-left direction. In short, the first reflection pattern RP1 and second reflection pattern RP2 are disposed in a mirror-image relationship with respect to the boundary therebetween.

A third reflection pattern RP3 of a third pixel PX3, which neighbors the first pixel PX1 in the column direction R, is identical to the second reflection pattern RP2. In short, the first pixel PX1 has the reflection pattern that is different from each of the reflection pattern of the second pixel PX2 neighboring the first pixel PX1 in the row direction C and the reflection pattern of the third pixel PX3 neighboring the first pixel PX1 in the column direction R.

With this structure, the same advantageous effects as with the first example of the structure (Example 1 of Structure) can be obtained.

### THIRD EXAMPLE OF STRUCTURE

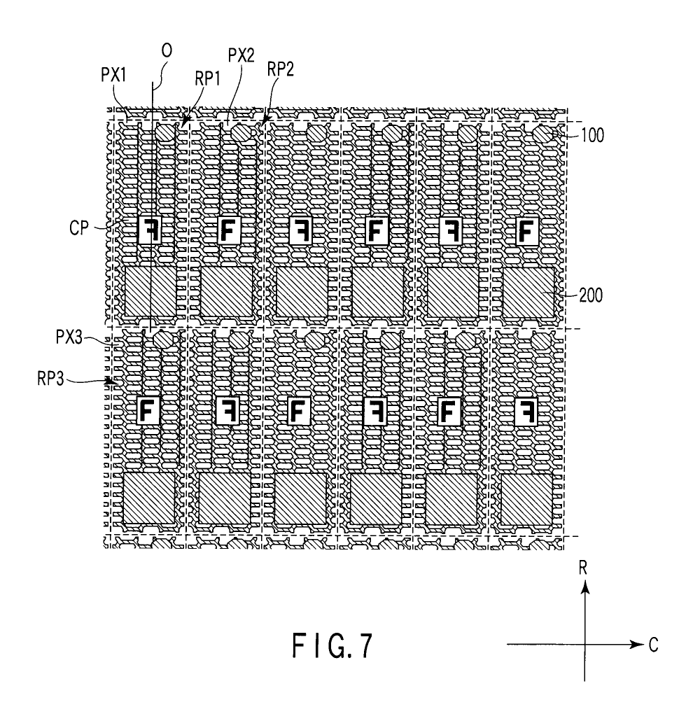

As is shown in FIG. 7, a reflection pattern RP of each of pixels PX is asymmetric with respect to a center line O of the pixel, which extends in the column direction R that is perpendicular to the major axis L of each projection CP. Specifically, the projections CP are provided in four columns in each pixel PX. Although the projections of three columns have the major axes L of the same length, each of the projections of the other column has a major axis whose length is different from the length of each of the projections of the above-mentioned three columns. In the example shown in FIG. 7, the major axis of each projection of the above-mentioned other column has a length that is about half the length of the major axis of each of the above-mentioned three columns. In this structure, too, the layouts of left-hand projections and right-hand projections are asymmetric with respect to the center line O.

If the first pixel PX1 is set as a reference pixel, each of a first reflection pattern RP1 of the first pixel PX1 and a second reflection pattern RP2 of a second pixel PX2, which neighbors the first pixel PX1 in the row direction C, is asymmetric with respect to the center line of each pixel. In addition, the second reflection pattern RP2 corresponds to a pattern which is obtained by inverting the first reflection pattern RP1 about the center line O in the right-and-left direction. In short, the first reflection pattern RP1 and second reflection pattern RP2 are disposed in a mirror-image relationship with respect to the boundary therebetween.

A third reflection pattern RP3 of a third pixel PX3, which neighbors the first pixel PX1 in the column direction R, is identical to the second reflection pattern RP2. In short, the first pixel PX1 has the reflection pattern that is different from each of the reflection pattern of the second pixel PX2 neighboring the first pixel PX1 in the row direction C and the reflection pattern of the third pixel PX3 neighboring the first pixel PX1 in the column direction R.

With this structure, the same advantageous effects as with the first example of the structure (Example 1 of Structure) can be obtained.

### FOURTH EXAMPLE OF STRUCTURE

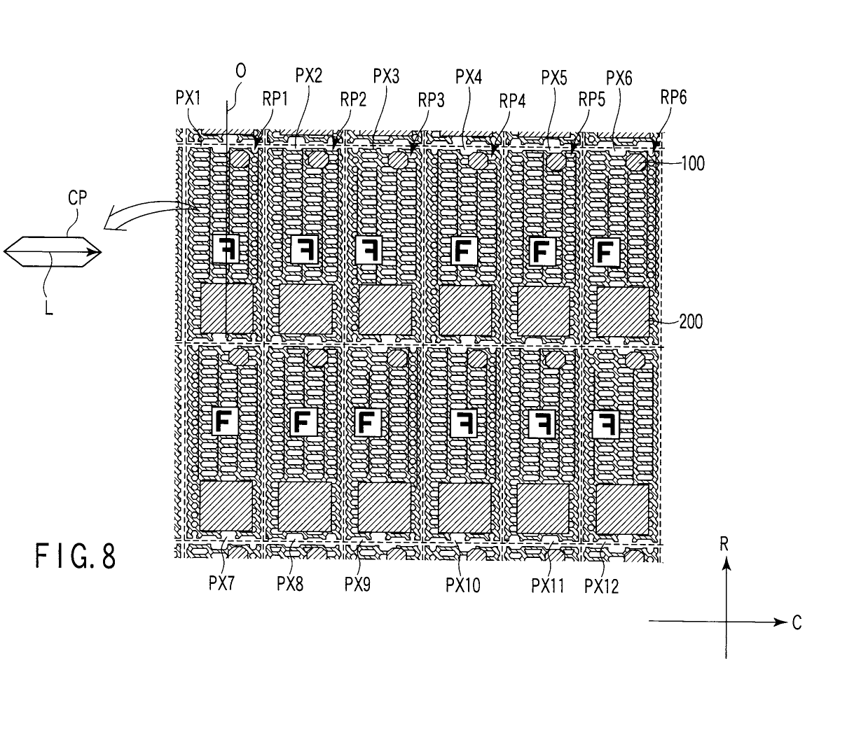

As is shown in FIG. 8, a reflection pattern RP of each of pixels PX is asymmetric with respect to a center line O of the pixel, which extends in the column direction R that is perpendicular to the major axis L of each projection CP. The basic layout of projections CP is the same as that of the first example of the structure.

When the first pixel PX1 is set as a reference pixel, a second reflection pattern RP2 of a second pixel PX2, which neighbors the first pixel PX1 in the row direction C, corresponds to a pattern which is obtained by displacing the first reflection pattern RP1 of the first pixel PX1 in the major-axis direction (i.e. row direction) by a pitch less than the length of the major axis L of each projection CP. Similarly, a third reflection pattern RP3 of a third pixel PX3, which neighbors the second pixel PX2 in the row direction C, corresponds to a pattern which is obtained by displacing the second reflection pattern RP2 of the second pixel PX2 in the major-axis direction by a pitch less than the length of the major axis L of each projection CP.

In this case, the pitch of displacement of each reflection pattern is equal. In this example, the pitch is set at ⅓ of the length of the major axis of the projection CP. The pitch of displacement is not limited to this example, and the pitch may be 1/n (n: a natural number).

A color-display-type liquid crystal display device is described here by way of example. One picture element is constituted by three pixels, i.e. a red pixel, a green pixel and a blue pixel. For example, the first pixel PX1 corresponds to the red pixel, the second pixel PX2 corresponds to the green pixel, and the third pixel PX3 corresponds to the blue pixel. Reflection patterns of the neighboring color pixels are shifted by a ⅓ pitch from each other, and thus the different reflection patterns are applied to the color pixels.

On the other hand, a fourth reflection pattern RP4 of a fourth pixel PX4, which neighbors the third pixel PX3 in the row direction C, corresponds to a pattern which is obtained by inverting the first reflection pattern RP1 about the center line of the pixel in the right-and-left direction. A fifth reflection pattern RP5 of a fifth pixel PX5, which neighbors the fourth pixel PX4 in the row direction C, corresponds to a pattern which is obtained by inverting the second reflection pattern RP2 about the center line of the pixel in the right-and-left direction. A sixth reflection pattern RP6 of a sixth pixel PX6, which neighbors the fifth pixel PX5 in the row direction C, corresponds to a pattern which is obtained by inverting the third reflection pattern RP3 about the center line of the pixel in the right-and-left direction.

A reflection pattern of a seventh pixel PX7, which neighbors the first pixel PX1 in the column direction R, corresponds to a pattern which is obtained by inverting the first reflection pattern RP1 about the center line of the pixel in the right-and-left direction. In short, the reflection pattern of the seventh pixel PX7 is identical to the fourth reflection pattern RP4. A reflection pattern of an eighth pixel PX8, which neighbors the second pixel PX2 in the column direction R, corresponds to a pattern which is obtained by inverting the second reflection pattern RP2 about the center line of the pixel in the right-and-left direction. In short, the reflection pattern of the eighth pixel PX8 is identical to the fifth reflection pattern RP5. A reflection pattern of a ninth pixel PX9, which neighbors the third pixel PX3 in the column direction R, corresponds to a pattern which is obtained by inverting the third reflection pattern RP3 about the center line of the pixel in the right-and-left direction. In short, the reflection pattern of the ninth pixel PX9 is identical to the sixth reflection pattern RP6.

A reflection pattern of a tenth pixel PX10, which neighbors the fourth pixel PX4 in the column direction R, is identical to the first reflection pattern RP1. A reflection pattern of an eleventh pixel PX11, which neighbors the fifth pixel PX5 in the column direction R, is identical to the second reflection pattern RP2. A reflection pattern of a twelfth pixel PX12, which neighbors the sixth pixel PX6 in the column direction R, is identical to the third reflection pattern RP3.

In other words, the picture element comprising the first pixel PX1, second pixel PX2 and third pixel PX3 and the picture element comprising the tenth pixel PX10, eleventh pixel PX11 and twelfth pixel PX12 have the same pattern. Similarly, the picture element comprising the fourth pixel PX4, fifth pixel PX5 and sixth pixel PX6 and the picture element comprising the seventh pixel PX7, eighth pixel PX8 and ninth pixel PX9 have the same pattern.

Red pixels includes, in addition to the first pixel PX1, the fourth pixel PX4, the seventh pixel PX7 and the tenth pixel PX10. Similarly, green pixels includes, in addition to the second pixel PX2, the fifth pixel PX5, the eighth pixel PX8 and the eleventh pixel PX11. Blue pixels includes, in addition to the third pixel PX3, the sixth pixel PX6, the ninth pixel PX9 and the twelfth pixel PX12.

In this structure, the pixels of the same color, which neighbor in the column direction R, have different reflection patterns. Thus, interference of reflective light of the same color can be suppressed, and the occurrence of moire can be reduced. Therefore, an image with good display quality can be displayed by making use of the reflective display function.

### FIFTH EXAMPLE OF STRUCTURE

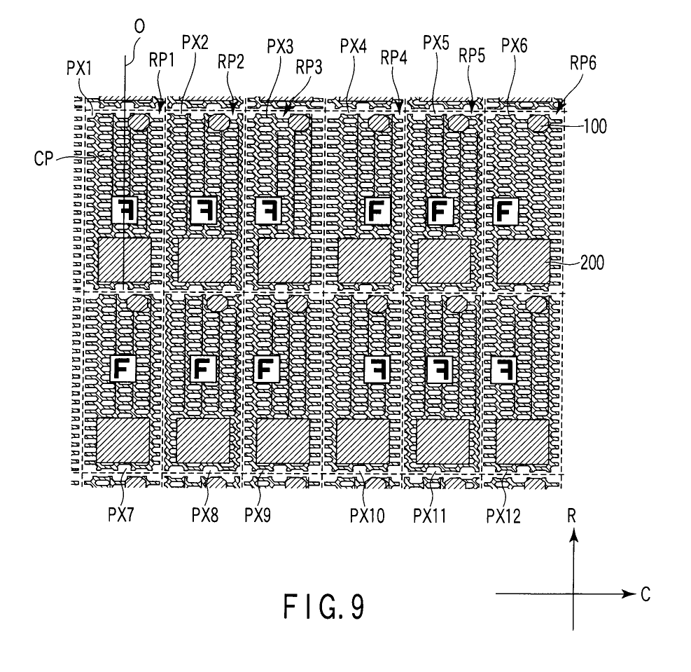

As is shown in FIG. 9, a reflection pattern RP of each of pixels PX is asymmetric with respect to a center line O of the pixel, which extends in the column direction R that is perpendicular to the major axis L of each projection CP. The basic layout of projections CP is the same as that of the second example of the structure.

In the fifth example of the structure, like the fourth example of the structure, the second reflection pattern RP2 of the second pixel PX2 corresponds to a pattern which is obtained by displacing the first reflection pattern RP1 of the first pixel PX1 in the major-axis direction (i.e. row direction) by a pitch less than the length of the major axis L of each projection CP. The third reflection pattern RP3 of the third pixel PX3 corresponds to a pattern which is obtained by displacing the second reflection pattern RP2 of the second pixel PX2 in the major-axis direction by a pitch less than the length of the major axis L of each projection CP. The pitch of displacement of each reflection pattern is equal. In this example, the pitch is set at ⅓ of the length of the major axis of the projection CP.

The fourth reflection pattern RP4 of the fourth pixel PX4 corresponds to a pattern which is obtained by inverting the first reflection pattern RP1 about the center line of the pixel in the right-and-left direction. The fifth reflection pattern RP5 of the fifth pixel PX5 corresponds to a pattern which is obtained by inverting the second reflection pattern RP2 about the center line of the pixel in the right-and-left direction. The sixth reflection pattern RP6 of the sixth pixel PX6 corresponds to a pattern which is obtained by inverting the third reflection pattern RP3 about the center line of the pixel in the right-and-left direction.

The reflection pattern of the seventh pixel PX7 is identical to the fourth reflection pattern RP4. The reflection pattern of the eighth pixel PX8 is identical to the fifth reflection pattern RP5. The reflection pattern of the ninth pixel PX9 is identical to the sixth reflection pattern RP6.

The reflection pattern of the tenth pixel PX10 is identical to the first reflection pattern RP1. The reflection pattern of the eleventh pixel PX11 is identical to the second reflection pattern RP2. The reflection pattern of the twelfth pixel PX12 is identical to the third reflection pattern RP3.

With this structure, the same advantageous effects as with the fourth example of the structure can be obtained.

### SIXTH EXAMPLE OF STRUCTURE

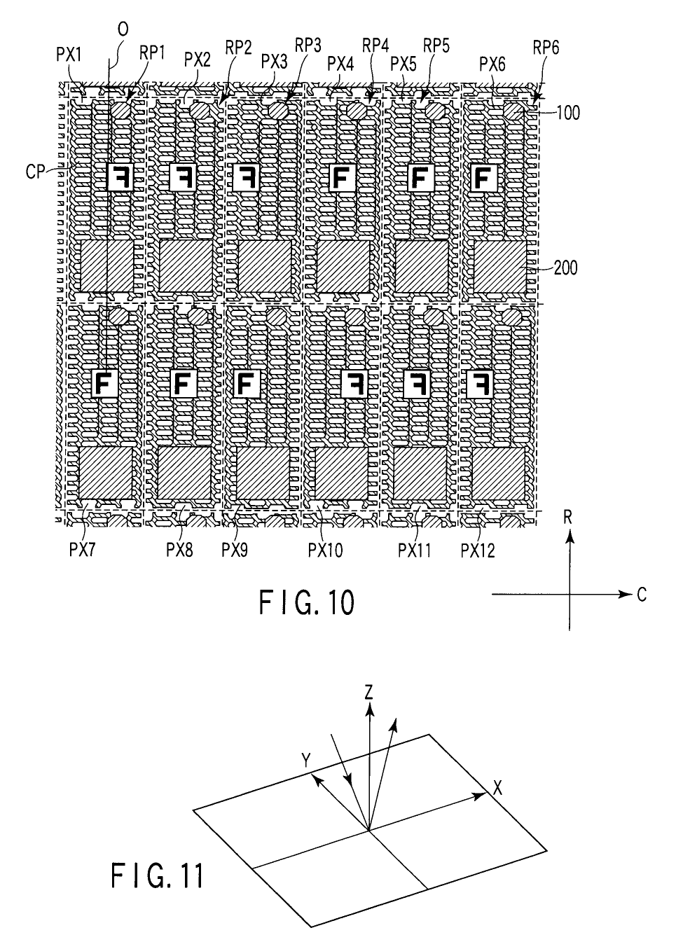

As is shown in FIG. 10, a reflection pattern RP of each of pixels PX is asymmetric with respect to a center line O of the pixel, which extends in the column direction R that is perpendicular to the major axis L of each projection CP. The basic layout of projections CP is the same as that of the third example of the structure.

In the sixth example of the structure, like the fourth example of the structure, the second reflection pattern RP2 of the second pixel PX2 corresponds to a pattern which is obtained by displacing the first reflection pattern RP1 of the first pixel PX1 in the major-axis direction (i.e. row direction) by a pitch less than the length of the major axis L of each projection CP. The third reflection pattern RP3 of the third pixel PX3 corresponds to a pattern which is obtained by displacing the second reflection pattern RP2 of the second pixel PX2 in the major-axis direction by a pitch less than the length of the major axis L of each projection CP. The pitch of displacement of each reflection pattern is equal. In this example, the pitch is set at ⅓ of the length of the major axis of the projection CP.

The reflection pattern of the fourth pixel PX4 corresponds to a pattern which is obtained by inverting the first reflection pattern RP1 about the center line of the pixel in the right-and-left direction. The reflection pattern of the fifth pixel PX5 corresponds to a pattern which is obtained by inverting the second reflection pattern RP2 about the center line of the pixel in the right-and-left direction. The reflection pattern of the sixth pixel PX6 corresponds to a pattern which is obtained by inverting the third reflection pattern RP3 about the center line of the pixel in the right-and-left direction.

The reflection pattern of the seventh pixel PX7 is identical to the fourth reflection pattern RP4. The reflection pattern of the eighth pixel PX8 is identical to the fifth reflection pattern RP5. The reflection pattern of the ninth pixel PX9 is identical to the sixth reflection pattern RP6.

The reflection pattern of the tenth pixel PX10 is identical to the first reflection pattern RP1. The reflection pattern of the eleventh pixel PX11 is identical to the second reflection pattern RP2. The reflection pattern of the twelfth pixel PX12 is identical to the third reflection pattern RP3.

With this structure, the same advantageous effects as with the fourth example of the structure can be obtained.

In the case where the reflection patterns shown in FIG. 5 to FIG. 10 are applied, it is preferable to set the major axis L of each projection CP of each reflection pattern to be substantially parallel to the row direction, i.e. the horizontal direction (X axis) of the screen, as shown in FIG. 11. With this setting, ambient light, which is incident from a vertical direction (Y axis) of the screen, can be reflected in a direction near the normal direction (Z axis) of the screen with good directivity, and the reflectance in a specified direction can further be improved.

As has been described above, the liquid crystal display device having the reflective display function of the present embodiment can display an image with good display quality.

The present invention is not limited directly to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

What is claimed is:

1. A liquid crystal display device including a plurality of pixels which are arrayed in a matrix, comprising:
a first substrate having, in each of the pixels, a reflection pattern which is configured such that a plurality of projections protruding from a substrate major surface are regularly arranged;
a second substrate which is disposed to be opposed to the first substrate; and
a liquid crystal layer which is held between the first substrate and the second substrate, wherein each of the projections has such a shape as to have a major axis in the substrate major surface,
a first reflection pattern in a first pixel differs from a second reflection pattern in a second pixel which neighbors the first pixel in a row direction of the first pixel, and
each of the first reflection pattern and the second reflection pattern is asymmetric with respect to a center line of the pixel, which extends in a direction that is perpendicular to the major axis of each projection.

2. The liquid crystal display device according to claim 1, wherein the first reflection pattern in the first pixel differs from a third reflection pattern in a third pixel which neighbors the first pixel in a column direction, and the third reflection pattern is asymmetric with respect to a center line of the pixel, which extends in a direction that is perpendicular to the major axis of each projection.

3. The liquid crystal display device according to claim 1, wherein the second reflection pattern corresponds to a pattern which is obtained by inverting the first reflection pattern about the center line.

4. The liquid crystal display device according to claim 2, wherein the third reflection pattern is identical to the second reflection pattern.

5. The liquid crystal display device according to claim 1, wherein the second reflection pattern corresponds to a pattern which is obtained by shifting the first reflection pattern by 1/n (n: a natural number) of a length of the major axis of the projection in a direction of the major axis.

6. The liquid crystal display device according to claim 2, wherein the second reflection pattern corresponds to a pattern which is obtained by shifting the first reflection pattern by 1/n (n: a natural number) of a length of the major axis of the projection in a direction of the major axis, and
the third reflection corresponds to a pattern which is obtained by inverting the first reflection pattern about the center line of the pixel.

7. The liquid crystal display device according to claim 1, wherein the first reflection pattern in the first pixel differs from a third reflection pattern in a third pixel which neighbors the second pixel in the row direction,
the third reflection pattern is asymmetric with respect to the center line of the pixel, which extends in a direction that is perpendicular to the major axis of the projection,
the second reflection pattern corresponds to a pattern which is obtained by shifting the first reflection pattern by ⅓ of a length of the major axis of the projection in a direction of the major axis, and
the third reflection pattern corresponds to a pattern which is obtained by shifting the second reflection pattern by ⅓ of the length of the major axis of the projection in the direction of the major axis.

8. The liquid crystal display device according to claim 1, wherein the second reflection pattern in the second pixel corresponds to a pattern which is obtained by shifting the first reflection pattern by 1/n of a length of the major axis of the projection in a direction of the major axis,
a third reflection pattern in a third pixel, which neighbors the second pixel in the row direction, corresponds to a pattern which is obtained by shifting the second reflection pattern by 1/n of the length of the major axis of the projection in the direction of the major axis, which is identical to a direction of the shift of the second reflection pattern relative to the first reflection pattern,
a fourth reflection pattern in a fourth pixel, which neighbors the third pixel in the row direction, corresponds to a pattern which is obtained by inverting the first reflection pattern about the center line of the pixel,
a fifth reflection pattern in a fifth pixel, which neighbors the fourth pixel in the row direction, corresponds to a pattern which is obtained by inverting the second reflection pattern about the center line of the pixel, and
a sixth reflection pattern in a sixth pixel, which neighbors the fifth pixel in the row direction, corresponds to a pattern which is obtained by inverting the third reflection pattern about the center line of the pixel.

9. The liquid crystal display device according to claim 8, wherein a seventh reflection pattern in a seventh pixel, which neighbors the first pixel in a column direction of the first pixel, is identical to the fourth reflection pattern,
an eighth reflection pattern in an eighth pixel, which neighbors the second pixel in the column direction, is identical to the fifth reflection pattern, and
a ninth reflection pattern in a ninth pixel, which neighbors the third pixel in the column direction, is identical to the sixth reflection pattern.

10. The liquid crystal display device according to claim 1, wherein the major axis of the projection is substantially parallel to the row direction.
